(19) United States
(12) Patent Application Publication
(10) Pub. No.: US 2026/0286150 A1
(43) Pub. Date: Sep. 24, 2026

(54) GRAPHENE OXIDE LIQUID COATING COMPOSITION CONTAINING PROPYLENE GLYCOL MONOMETHYL ETHER AND WATER

(71) Applicant: Evercloak Inc., Kitchener (CA)

(72) Inventors: Nathan Julius GRISHKEWICH, Kitchener (CA); Mahshid CHEKINI, Waterloo (CA); Matthew A. HEUFT, Oakville (CA)

(73) Assignee: Evercloak Inc., Kitchener (CA)

(21) Appl. No.: 19/557,515

(22) Filed: Mar. 5, 2026

Related U.S. Application Data
(60) Provisional application No. 63/774,307, filed on Mar. 19, 2025.

(30) Foreign Application Priority Data
Mar. 27, 2025 (CA) 3,268,984

(51) Int. Cl. C09D 7/61; C08K 3/04; C09D 7/20; C09D 101/02

(52) U.S. Cl. CPC C09D 7/61; C09D 7/20; C09D 101/02; C08K 3/042; C08K 2201/011

(57) ABSTRACT

A graphene oxide liquid coating composition contains graphene oxide (GO) suspended in a liquid medium. The liquid medium contains at least 80% by volume of a mixture of water and propylene glycol monomethyl ether (PGME). The mixture of water and PGME has a volume ratio of PGME:water in a range of 85:15 to 95:5. The graphene oxide ink composition has an improved shelf-life and can be used to fabricate GO-containing membranes.

### CROSS-REFERENCE TO RELATED APPLICATIONS

This application claims the benefit of U.S. Ser. No. 63/774,307 filed Mar. 19, 2025 and claims priority to Canadian application CA 3,268,984 filed Mar. 27, 2025, the entire contents of both of which are herein incorporated by reference.

### FIELD

This application relates to coating compositions useful for producing graphene oxide-containing membranes.

### BACKGROUND

Graphene oxide (GO) membranes find use in air dehumidification with the primary aim of separating water vapor from air. GO membranes are usually fabricated by depositing a liquid coating composition comprising a suspension of GO in a liquid medium (i.e., a GO ink) on to a substrate material and then removing the liquid medium to provide a GO layer on the substrate material. To successfully produce a useful GO membrane, the coating composition must remain sufficiently stable before use to prevent the formation of defects in the GO membrane when the liquid coating composition is finally applied to the substrate material. A GO liquid coating composition is said to have “expired” when air permeance through a GO membrane made with the liquid coating composition rises above a target performance threshold. Currently, GO liquid coating compositions prepared with liquid media such as ethanol/water mixtures are sufficiently stable for no more than 14 days.

There remains a need for a graphene oxide (GO) liquid coating composition that remains sufficiently stable for longer periods of time to remain useful in the production of GO-containing membranes.

### SUMMARY

Described herein is a graphene oxide liquid coating composition comprising graphene oxide (GO) suspended in a liquid medium, the liquid medium comprising at least 80% by volume of a mixture of water and propylene glycol monomethyl ether (PGME), the mixture having a volume ratio of PGME:water in a range of 80:20 to 95:5.

Also described herein is a method of producing a graphene oxide-containing membrane comprising: coating a substrate with the graphene oxide liquid coating composition defined above; and, removing the liquid medium from the coated substrate.

The graphene oxide liquid coating composition has a shelf-life of more than 14 days from when the liquid coating composition was first formulated. In some embodiments, the shelf-life is 15 days or more. In some embodiments, the shelf-life is 20 days or more. In some embodiments, the shelf-life is 25 days or more. In some embodiments, the shelf-life is 28 days or more. The shelf-life is the length of time, starting from when the GO liquid coating composition is first formulated, over which the GO liquid coating composition remains sufficiently stable to be able to produce a GO-containing membrane having an air permeance below a target performance threshold. The target performance threshold for air permeance of the GO-containing membranes is 1.41E-8 mol/s/m²/Pa based on maintaining a minimum membrane water/air selectivity of 400. Undesirably high air permeance of a GO-containing membrane can result from coating composition components (e.g., graphene oxide and/or other solid components) not forming a stable dispersion in the liquid medium, which can result in solid composition components aggregating in suspension and/or settling in the liquid coating composition causing a solid content concentration gradient, thereby preventing the components from uniformly covering the substrate to form of a smooth flat film during coating. The inability to produce a uniform, smooth film of the liquid coating composition components during coating reduces air blocking ability of the film thereby increasing air permeance.

In addition, the GO liquid coating composition mitigates GO agglomeration issues and subsequent coating defects in doctor blading and roll-to-roll coating processes for producing GO-containing membranes.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A depicts a graph of air permeance (mol/s/m²/Pa) vs. Day for Sample C1 having a liquid medium comprising an EtOH:water ratio of 90:10 v/v.

FIG. 1B depicts a graph of air permeance (mol/s/m²/Pa) vs. Day for Sample C2 having a liquid medium comprising an EtOH:water ratio of 80:20 v/v.

FIG. 1C depicts a graph of air permeance (mol/s/m²/Pa) vs. Day for Sample I4 having a liquid medium comprising a PGME:water ratio of 90:10 v/v.

FIG. 2A depicts a graph of air permeance (mol/s/m²/Pa) of GO-containing membranes produced from freshly prepared Samples C2, C6, I1 and I2 in relation to a target value of 1.41E-8 mol/s/m²/Pa, shown as a horizontal line in FIG. 2A.

FIG. 2B depicts a graph of water vapor permeance (mol/s/m²/Pa)*10⁻⁶ of the GO-containing membranes produced from the samples at relative humidities (RH) of 50%, 70% and 90%.

FIG. 2C depicts a graph of air permeance (mol/s/m²/Pa) of GO-containing membranes produced from freshly prepared Samples C2, C3, C4 and C5 in relation to the target value of 1.41E-8 mol/s/m²/Pa, shown as a horizontal line in FIG. 2C.

FIG. 2D depicts a graph of water vapor permeance (mol/s/m²/Pa)*10⁻⁶ of the GO-containing membranes produced from the samples C2, C3 and C4 at relative humidities (RH) of 50%, 70% and 90% in relation to a baseline for Sample C1 shown as a line on the graph in FIG. 2D.

FIG. 3 depicts a graph of viscosity (mPa*s) vs. shear rate (s⁻¹) for Samples C2, C3, C4, C5, C6, I1 and I2 having liquid media comprising different co-solvents with water.

FIG. 4A depicts a graph of air permeance (mol/s/m²/Pa) of GO-containing membranes produced from the samples in relation to the target value of 1.41E-8 mol/s/m²/Pa, shown as a horizontal line in FIG. 4A.

FIG. 4B depicts a graph of water vapor permeance (mol/s/m²/Pa)*10⁻⁶ of the GO-containing membranes produced from the samples at relative humidities (RH) of 50%, 70% and 90% in relation to a baseline for Sample C1 shown as a line on the graph in FIG. 4B.

### DETAILED DESCRIPTION

Graphene oxide (GO) is an electrically insulating material composed of a single graphene sheet with oxygen functional groups bonded as epoxy groups to the graphene basal-plane and carboxyl groups and hydroxyl groups bonded to the edge of the sides of the GO sheets. Graphene oxide (GO) can be obtained from the exfoliation of graphite oxide or during the process of graphite oxidation which is used to make graphite oxide or graphene oxide by known methods. When suspended, the GO sheets possess a high surface-to-volume ratio. In addition, GO can form a stable aqueous suspension due to the presence of the carboxylic acid groups and phenolic hydroxyl groups on the edge of the side of the GO sheets. The carboxyl, hydroxyl and/or epoxy moieties are available for condensation reactions with appropriate reactive molecules. In some embodiments, the graphene oxide is suspended in the liquid medium at a concentration in a range of 1-50 mg/mL. In some embodiments, concentration is in a range of 10-25 mg/mL. In some embodiments, concentration is in a range of 15-20 mg/mL.

The liquid medium comprises at least 80% by volume of a mixture of water and propylene glycol monomethyl ether (PGME). In some embodiments, the liquid medium comprises at least 90% by volume of the mixture of water and PGME. In some embodiments, the liquid medium comprises at least 95% by volume of the mixture of water and PGME. In some embodiments, the liquid medium comprises 100% by volume of the mixture of water and PGME (i.e., the liquid medium consists of water and PGME.

The mixture of water and PGME has a volume ratio (v/v) of PGME:water in a range of 80:20 to 95:5. In some embodiments, the volume ratio of PGME:water is in a range of 85:15 to 95:5. In some embodiments, the volume ratio of PGME:water is in a range of 86:14 to 94:6. In some embodiments, the volume ratio of PGME:water is in a range of 87:13 to 93:7. In some embodiments, the volume ratio of PGME:water is in a range of 88:12 to 92:8. In some embodiments, the volume ratio of PGME:water is in a range of 89:11 to 91:9. In some embodiments, the volume ratio of PGME:water is 90:10.

In some embodiments, one or the other of the water and the PGME are purified, for example by distillation, deionization, reverse osmosis, filtration or any combination thereof. In some embodiments, both the water and the PGME are purified.

In some embodiments, the GO liquid coating composition further comprises one or more other solid components suspended in the liquid medium. In some embodiments, the one or more other solid components comprises a cellulose nanomaterial (e.g., aldehyde-modified cellulose nanofibers (aCNF), unmodified cellulose nanofibers, and the like). In some embodiments, each of the other solid components may be present in the liquid medium at a concentration in a range of 0.1-10 mg/mL.

In some embodiments, the one or more other solid components comprises a cellulose nanomaterial. The cellulose nanomaterial may be a native cellulose material or a synthetic cellulose material comprising a polymer derived from a native cellulose material. The native cellulose material may originate from any source such as plants (e.g., softwood plants, hardwood plants, other plants), tunicates, bacteria or combinations thereof. The cellulose nanomaterial has at least one dimension (e.g., width or both width and length) that is less than 1000 nm in size, preferably 1-500 nm, more preferably 1-100 nm, yet more preferably 2-75 nm. The cellulose nanomaterial may be in any form, for example nanofibers or nanocrystals. Cellulose nanofibers are preferred. Cellulose nanofibers (CNF) are fibrillar structures comprising high aspect ratio rod-like fibers with a typical diameter of 2 to 50 nanometers and a wide range of lengths up to 1 mm, preferably up to 500 microns. The CNF preferably have length-to-diameter aspect ratio of at least 10:1, or at least 50:1 or at least 100:1, or at least 500:1. The length-to-diameter aspect ratio is preferably in a range of 10:1 to 10,000:1, more preferably in a range of 100:1 to 1,000:1.

In some embodiments, the cellulose nanomaterial comprises an aldehyde-modified cellulose nanomaterial (ACN). The ACN possesses aldehyde functional groups that are available for a condensation reaction with appropriate reactive molecules. Aldehyde modification of a cellulose material may be accomplished in any suitable manner. For example, aldehyde modification may be accomplished by oxidation of carbon-carbon bonds between adjacent hydroxyl groups in the pyranose ring of the cellulose material. In one embodiment, sodium periodate oxidation of the carbon-carbon bond results in the formation of two aldehyde groups that are reactive in condensation reactions. The carbon atom at the carbon-oxygen double-bond of the aldehyde moiety is an electrophile, which can react with nucleophiles.

Viscosity of the GO liquid coating composition can play a role in coating a substrate without forming coating defects. In some embodiments, the viscosity of the GO liquid coating composition is in a range of 28 mPa*s @21° C. at a shear rate of 1000 s⁻¹ to 2,054 mPa*s @21° C. at a shear rate of 1 s⁻¹ or 233 mPa*s @21° C. at a shear rate of 20 s⁻¹ to 30,000 mPa*s @21° C. at a shear rate of 0.1 s⁻¹.

The combination of GO and all other solid components results in the GO liquid coating composition having a total solids content. Increasing the total solids content of the GO liquid coating composition increases viscosity. Depending on the coating application, there may be a desirable minimum and/or maximum total solids content to ensure that the viscosity of the GO liquid coating composition is not too low or too high. In some embodiments, the total solids content is 15 mg/mL or more. In some embodiments, the total solids content is 27 mg/mL or less. In some embodiments, the total solids content is 25 mg/mL or less.

Formulating the GO liquid coating composition comprises mixing the graphene oxide, and any other solid components, with the water and the propylene glycol monomethyl ether (PGME) to form a stable suspension. Any suitable mixer may be utilized, for example mechanical stirring devices, ultrasonicating devices, high-pressure homogenization devices and the like. In some embodiments, high shear mixing, for example high shear mechanical stirring combined with ultrasonication, is used to promote formation of a homogeneous suspension. In some embodiments, stirring speeds are 1300 rpm or greater. In some embodiments, stirring speeds are increased, for example to a speed of 1500 rpm or greater, as the liquid coating composition thickens over time. In some embodiments, mixing the components of the liquid coating composition is performed for 1 minute or more. In some embodiments, mixing the components of the liquid coating composition is performed for 5 minutes or more. In some embodiments, mixing the components of the liquid coating composition is performed for 10 minutes or more. In some embodiments, all the components are mixed simultaneously. In some embodiments, ultrasonication at an amplitude of 90% with a power of 500 W for a 2-hour duration is used. In some embodiments, ultrasonication at an amplitude of 90% with a power of 500 W for a 3-hour duration is used.

The GO liquid coating composition can be used to produce a graphene oxide-containing membrane. In producing the graphene oxide-containing membrane, the GO liquid coating composition is coated on to a substrate. The graphene oxide liquid coating composition may be coated on to the substrate by any suitable method, for example, doctor blading, roll-to-roll printing (e.g., slot die coating, reverse roll coating, mayer rod coating), screen printing, gravure printing, aerosol printing, etc. The GO-containing membrane may then be dried to remove the liquid medium, for example by one or more of evaporation (with or without heat), application of a vacuum, etc.

The substrate preferably comprises an organic polymer. The organic polymer may comprise a homopolymer, a copolymer, a terpolymer, or a mixture thereof. The organic polymer may comprise amorphous or crystalline polymers. The organic polymer may comprise hydrophobic or hydrophilic polymers. The organic polymer may comprise linear, branched, star, cross-linked or dendritic polymers or mixtures thereof. The organic polymer may be a thermoplastic, thermoset and/or elastomeric polymers. A given organic polymer may be classifiable into more than one of the foregoing categories. Various substrates are disclosed in International patent publication WO 2023/184017 published Oct. 5, 2023.

Thermoplastic or elastomeric organic polymers are preferred. Thermoplastic organic polymers are particularly preferred. Some suitable thermoplastic polymers include, for example, olefinics (i.e., polyolefins), vinylics, styrenics, acrylonitrilics, acrylics, cellulosics, polyamides, thermoplastic polyesters, thermoplastic polycarbonates, polysulfones, polyimides, polyether/oxides, polyketones, fluoropolymers, copolymers thereof, or mixtures thereof. Preferred examples of organic polymers include polyamide (e.g., Nylon™), polyethylene (PE), polyethylene terephthalate (PET), polypropylene (PP), polyacrylonitrile (PAN) polysulfone (PSU), polyethersulfone (PES), polyvinylidene difluoride (PVDF), mixed cellulosic organic ester, cellulose acetate, thermoplastic polycarbonate (PC), thermoplastic polyester (PETE) or combinations thereof. Of particular interest are organic polymers useful in water vapor separation applications. To obtain the best adhesion of the composite film to the substrate, films and substrates that do not actively swell in the presence of water are preferred. To this end, olefinics are a preferred class of organic polymers for use as a substrate. Ultrahigh molecular weight porous polyethylene and porous polypropylene substrates are particularly preferred substrates.

The substrate is porous to a molecule of interest. Depending on the molecule of interest, the substrate contains pores having a minimum pore diameter to permit permeation of the molecule of interest through the substrate. The molecule of interest may be, for example, water, etc.

### EXAMPLES

### Materials and Methods

### Method for Producing Graphene Oxide (GO)

Graphene oxide is prepared using an improved Hummers method based on a method described in Marcano, D C, et al. Improved Synthesis of Graphene Oxide. ACS Nano 2010, 4 (8), 4806-4814. In a typical synthesis, 360 mL of sulfuric acid (Sigma-Aldrich, 95-98%) is mixed with 40 mL of phosphoric acid (Sigma-Aldrich, extra pure, 85% solution in water) in a round bottom flask. Next, 18 g of potassium permanganate (Sigma-Aldrich) is carefully added to the acid mixture under stirring at room temperature. The flask containing the mixture is then heated up to about 40° C. using a mantle heater or in an oil bath using a hot plate. After stabilizing the temperature, 3 g of graphite (Alfa Aesar, −10 mesh, 99.9%) is added to the flask under stirring. Next, the temperature is increased to 45-50° C., and the mixture is left under stirring for 16 h. After 16 hours of reaction, the mixture is cooled down to room temperature and slowly transferred into a large beaker filled with 400 g of ice. Once the mixture cools down to room temperature, the mixture is quenched by the addition of 7 mL hydrogen peroxide (Sigma-Aldrich, 30%) which results in a change of color from dark brown to golden.

Using a centrifugation step, the GO is separated from the acidic mixture. To further purify the GO, the GO is subjected to a few rounds of centrifugation, redispersion in 10% HCl (Sigma-Aldrich), followed by a few more rounds of centrifugation and redispersion in PGME (Fisher Scientific) to eliminate remaining reaction residues and impurities. The GO paste is stored in a sealed glass jar in dark.

### Method for Producing Aldehyde-Modified Cellulose Nanomaterials (ACN)

To modify the surface of nanocellulose a sodium periodate mediated oxidation method was used to cleave the C2-C3 bond in the pyranose ring of the cellulose unit resulting in the conversion of secondary alcohol to dialdehyde groups on the surface of the nanocellulose. Sodium periodate mediated oxidation can also be used to introduce aldehyde (reactive carbonyl) groups to polysaccharides and other sugar-containing macromolecules such as carbohydrates or glycoproteins. Sodium periodate mediated oxidation methods are described in the following references: Periodate Oxidation of Crystalline Cellulose: Biomacromolecules 2000, 1, 488-492; Improving the mechanical and thermal properties of gelatin hydrogels cross-linked by cellulose nanowhiskers, http://dx.doi.org/10.1016/j.carbpol.2012.08.080; Sodium periodate oxidation of cellulose nanocrystal and its application as a paper wet strength additive, Bo Sun, et al., DOI 10.1007/s10570-015-0575-5).

In a typical procedure, a highly concentrated cellulose nanomaterial (CN) paste was diluted in deionized water to obtain dilute dispersions of 1-5 wt % of the CN. To this dispersion, sodium periodate was added to achieve a final CN to sodium periodate weight ratio of 1:4. The mixture was left under stirring at 22° C. in dark for 24 hours. The reaction was quenched with the addition of ethylene glycol and the final product was purified by dialysis against deionized water for 5 days using cellulose membrane (Sigma; MWCO: 14000 Da). The aldehyde-modified cellulose nanomaterials (ACNs) were collected using centrifugation by 2870 RCF for 30 minutes and redispersed in ethanol.

Cellulose nanofibers (CNF) were used to produce aldehyde-modified cellulose nanofibers (aCNF). CNFs were acquired from the University of Maine with nominal fiber width of 50 nm and lengths of up to several hundred microns. The CNFs have a hydrophilic surface with 31-33 m²/g surface area determined by BET method (Brunauer-Emmett-Teller).

### Method for Testing Viscosity

Viscosity measurements were performed using an Anton-Paar ViscoQC 100 L Rotational viscometer. Samples of liquid coating composition were measured to a fixed volume and added into rotational geometry, and viscosity was measured at fixed rotational speeds of instrument, the latter of which was converted to a shear rate based on the measurement geometry used (closest method is ASTM D2196-10). Measurements were conducted at room temperature, usually 20-21° C.

### Method for Testing Water Permeance

The water vapor permeance for the membrane is defined as the molar flow rate across the membrane per unit area per unit pressure (with pressure defined as the transmembrane water vapor partial pressure). To quantify this value, as prepared GO-containing membranes were inserted into a custom-made system where humid air was flowed across the membrane (feed gas) while vacuum was applied on the other side. Using this test cell, the water vapor permeance of the GO-containing membranes can be calculated using:

$${Perm}_{water} = \frac{n}{A \times Δ {P}_{water}}$$

where Perm_{water} represents the water vapor permeance of the GO-containing membrane (mol·s⁻¹·m⁻²·Pa⁻¹), n represents the molar flowrate of water vapor across the membrane (mol/s), A is the active area of membrane in the test cell (m²), and ΔP_{water} is the transmembrane water vapor partial pressure, which is estimated using the following equations:

$$Δ {P}_{w a t e r} = \frac{Δ {P}_{a} - Δ {P}_{b}}{ln Δ {P}_{a} - ln Δ {P}_{b}}$$

$$Δ {P}_{a} = [ R {H}_{i n} * {P}_{0 , water} ( {T}_{i n} ) ] - [ R {H}_{vac} * {P}_{0 , water} ( {T}_{vac} ) ]$$

$$Δ {P}_{b} = [ R {H}_{out} * {P}_{0 , water} ( {T}_{out} ) ] - [ R {H}_{vac} * {P}_{0 , water} ( {T}_{vac} ) ]$$

$${P}_{0 , water} ( T ) = 0.61121 \times exp [ ( 18.678 - \frac{T}{234.5} ) \times ( \frac{T}{234.5 + T} ) ]$$

where P_{0,water}(T) represents the saturated vapor pressure of water at temperature T (in the last equation, T is in ° C.), RHᵢₙ and Tᵢₙ are relative humidity and temperature of the feed gas inlet respectively, RHₒᵤₜ and Tₒᵤₜ are relative humidity and temperature of the feed gas out let, respectively, and RH_{vac} and T_{vac} are relative humidity and temperature of the gas on the vacuum side of the membrane, respectively.

### Method for Testing Air Permeance

The air permeance for the membrane is defined as the molar flow rate across the membrane per unit area per unit pressure (with pressure defined as the transmembrane air partial pressure). To quantify this value, as prepared GO-containing membranes were inserted into a custom-made system where stagnant air could exist above the membrane while a vacuum was pulled on the other side. Using this test cell, the air permeance of the GO-containing membranes can be calculated using:

$${Perm}_{air} = \frac{n}{A \times Δ {P}_{air}}$$

where Permₐᵢᵣ represents the air permeance of the GO or aCNF: GO coated membrane (mol·s⁻¹·m⁻²·Pa⁻¹), n represents the molar flowrate of air across the membrane (mol/s), A is the active area of membrane in the test cell (m²), and ΔP_{water} is the transmembrane water vapor partial pressure, which is estimated using the following equations:

$$Δ {P}_{air} = {P}_{at m} - {P}_{vac}$$

where Pₐₜₘ is atmospheric pressure (Pa) and P_{vac} is the pressure on the vacuum side of the

### Formulation of GO Liquid Coating Compositions

For preparation of liquid coating compositions, concentrated GO paste along with concentrated aqueous aCNF was mixed with PGME (or EtOH or EGPE), and was subjected to magnetic stirring at approximately 500 rpm before sonication to form a suspension at 20.6 mg/mL. This was followed via probe ultrasonication at a power of 500 W at an amplitude of 90% for 25 minutes. Following this, water was added to reduce the solids concentration to 20.6 mg/ml and form a 9:1 V:V ratio of PGME:Water, and the mixture was further sonicated for 5 minutes, resulting in a stable dispersion. The final ink composition consisted of 80 wt % GO and 20 wt % aCNF based on the sum of the weights of the GO and aCNF.

### Coating of GO Liquid Coating Compositions on Substrates

### Pre-Treatment of Porous Polyethylene (PE) Substrate to Oxidize the Surface of the PE

Prior to coating, the substrate was secured in place and a corona treatment wand held 0.125 inch above the surface of the substrate was moved across the surface at a linear speed of 1 cm/s for four passes. The resulting surface modification changes the water contact angle on the surface from 105 degrees to 55 degrees.

### Preparation of Membrane Via Casting

Coating the substrate with the above formulations was accomplished using a tape casting method via doctor blade. In a typical procedure, a porous substrate was secured on a flat surface (i.e. glass). A doctor blade was placed at the front edge of the substrate, and the blade gap was adjusted to the desired height (i.e. 80 μm). The formulation was dispensed evenly in front of the doctor blade close to the front edge of the substrate, and the doctor blade was moved at a speed of 1 inch/s to create a thin liquid film. Following this, a heat gun was aimed at the coating from the height of 2 feet to evaporate remaining coating solvent to obtain a dried film.

### Shelf-Life Testing

To assess shelf-life of GO liquid coating compositions, the liquid coating compositions were produced as described above and stored in a dry, dark location. The liquid coating compositions were tested periodically (e.g., on a daily basis) via blading as described above to produce GO-containing membranes. Membrane quality was assessed based on air permeance and water vapor permeance. When the air permeance of a membrane produced from a stored liquid coating composition reached or exceeded 1.41E-8 mol/s/m²/Pa while maintaining a minimum membrane water/air selectivity of 400, the liquid coating composition used to produce that membrane was said to have reached its maximum shelf-life.

### Example 1—Sample Liquid Coating Compositions

Graphene oxide liquid coating compositions were formulated as described above in accordance with the compositional components in Table 1. GO is graphene oxide. aCNF is aldehyde modified cellulose nanofibers. Total solids is the sum of the GO and aCNF concentrations. Solvent 1 together with the water constitute 100 vol % of the liquid medium used for the liquid coating compositions. EtOH is ethanol, EGPE is ethylene glycol propyl ether. PGME is propylene glycol monomethyl ether.

TABLE 1

| | GO | aCNF | Total Solids | Solvent 1 | Water |
|---|---|---|---|---|---|
| Sample | (mg/mL) | (mg/mL) | (mg/mL) | (v/v %) | (v/v %) |
| C1 | 13.0 | 3.3 | 16.3 | 90 (EtOH) | 10 |
| C2 | 16.5 | 4.1 | 20.6 | 80 (EtOH) | 20 |
| C3 | 16.5 | 4.1 | 20.6 | 94 (EGPE) | 6 |
| C4 | 16.5 | 4.1 | 20.6 | 90 (EGPE) | 10 |
| C5 | 16.5 | 4.1 | 20.6 | 80 (EGPE) | 20 |
| C6 | 16.5 | 4.1 | 20.6 | 94 (PGME) | 6 |
| I1 | 16.5 | 4.1 | 20.6 | 90 (PGME) | 10 |
| I2 | 16.5 | 4.1 | 20.6 | 80 (PGME) | 20 |
| I4 | 18.6 | 4.6 | 23.2 | 90 (PGME) | 10 |
| I5 | 21.7 | 5.4 | 27.1 | 90 (PGME) | 10 |

### Example 2—Shelf-Life Comparisons

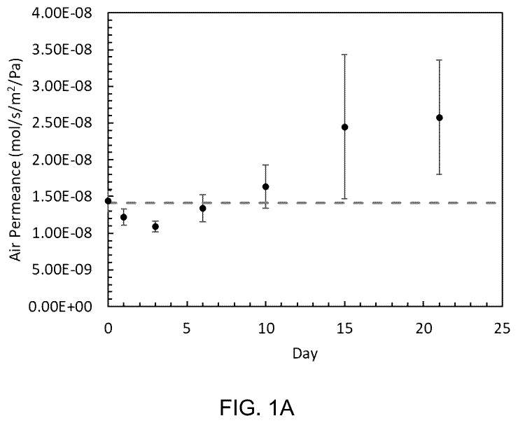

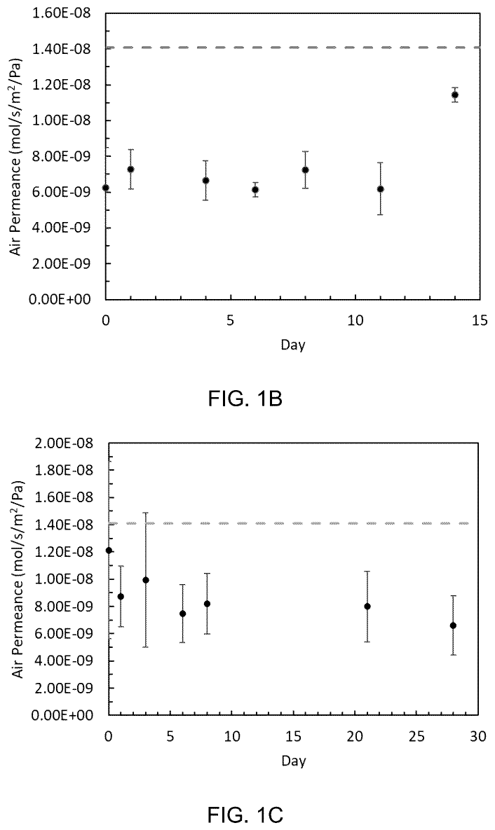

The shelf-lives of Samples C1, C2 and I4 were examined. FIG. 1A depicts a graph of air permeance (mol/s/m²/Pa) vs. Day for Sample C1 in relation to the target value of 1.41E-8 mol/s/m²/Pa, shown as a horizontal line in FIG. 1A. FIG. 1B depicts a graph of air permeance (mol/s/m²/Pa) vs. Day for Sample C2 in relation to the target value of 1.41E-8 mol/s/m²/Pa, shown as a horizontal line in FIG. 1B. FIG. 1C depicts a graph of air permeance (mol/s/m²/Pa) vs. Day for Sample I4 in relation to the target value of 1.41E-8 mol/s/m²/Pa, shown as a horizontal line in FIG. 1C. Sample C1 exhibited a shelf-life of less than 10 days from the day of formulation of the sample. Sample C2 exhibited a shelf-life of about 14 days from the day of formulation of the sample. Sample I4 exhibited a shelf-life of at least 28 days from the day of formulation of the sample.

In addition, in testing Sample C1 a Mayer rod was used to coat the sample on polyamide and polyethylene substrates. After having been stored for 8 days from the day of formulation of the sample, the deposition of Sample C1 on both the polyamide and polyethylene substrates resulted in defects in the coatings. The defects arose from agglomeration of the liquid coating composition in grooves of the rod with subsequent evaporation of liquid medium from the liquid coating composition deposited in the grooves. A steady increase in the viscosity of Sample C1 was observed over the course of the storage time.

In testing Sample C2, coating defects relating to “gator skinning” due to inadequate adhesion of coatings on polyethylene material during slot die coating were also observed. Additionally, ribbing was observed in the coating direction on both polyethylene and polyamide substrates caused by agglomeration of particles of the liquid coating composition in the slot die head and coating lip. A steady increase in the viscosity of Sample C2 was also observed over the course of the storage time.

In testing sample I4, coating defects, that arose for Samples C1 and C2, were not observed. Thus, Sample I4 has both a longer shelf-life than Samples C1 and C2 and addresses agglomeration issues that were observed for Samples C1 and C2. A steady increase in the viscosity of Sample I4 was also observed over the course of the storage time.

### Example 3—Air and Water Vapor Permeance Comparisons

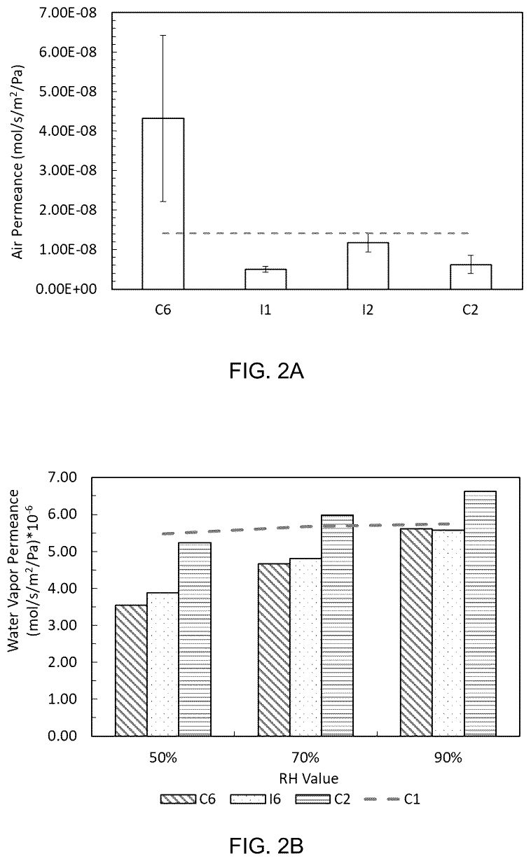

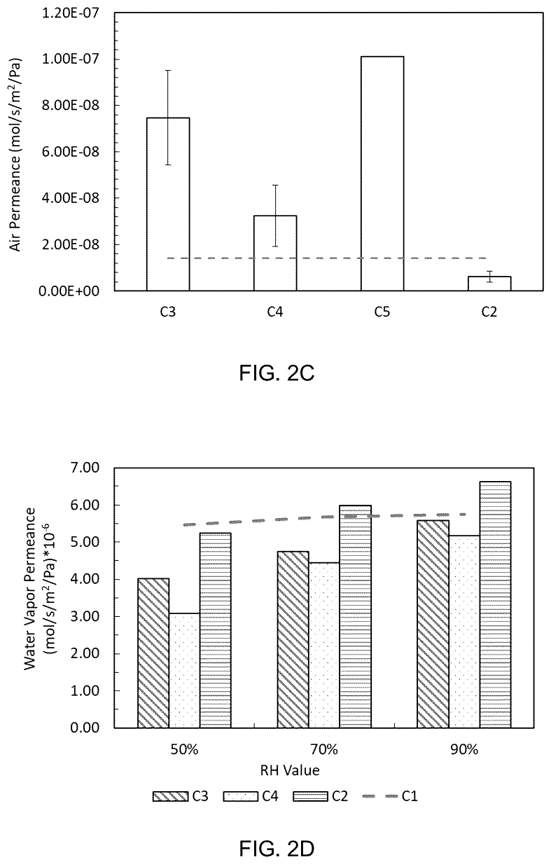

Air permeance and water vapor permeance (WVP) for GO-containing membranes produced from freshly prepared samples of Samples C2, C6, I1 and I2 were examined. FIG. 2A depicts a graph of air permeance (mol/s/m²/Pa) of GO-containing membranes produced from the samples in relation to the target value of 1.41E-8 mol/s/m²/Pa, shown as a horizontal line in FIG. 2A. FIG. 2B depicts a graph of water vapor permeance (mol/m²*s*Pa)*10⁻⁶ of the GO-containing membranes produced from the samples at relative humidities (RH) of 50%, 70% and 90% in relation to a baseline for Sample C1 shown as a line on the graph in FIG. 2B.

GO-containing membranes produced from freshly prepared samples of Samples I1 and I2 (both containing PGME and water) both had an initial air permeance (FIG. 2A) lower than the target performance threshold with I1 having an air permeance lower than Sample C2. That sample C6 (PGME:Water of 94:6) had an initial air permeance greater than the target performance threshold indicates that even with improved shelf stability, the ratio of PGME to water is an important parameter in determining the usefulness of the liquid coating compositions containing PGME and water.

FIG. 2B illustrates that PGME-containing liquid coating compositions result in GO-containing membranes having reduced WVP compared to Sample C2 containing a ratio of EtOH:water of 80:20.

Air permeance and water vapor permeance for GO-containing membranes produced from freshly prepared samples of Samples C2, C3, C4 and C5 were also examined. FIG. 2C depicts a graph of air permeance (mol/s/m²/Pa) of GO-containing membranes produced from the Samples C2, C3, C4 and C5 in relation to the target value of 1.41E-8 mol/s/m²/Pa, shown as a horizontal line in FIG. 2C. FIG. 2D depicts a graph of water vapor permeance (mol/m²*s*Pa)*10⁻⁶ of the GO-containing membranes produced from the samples C2, C3 and C4 at relative humidities (RH) of 50%, 70% and 90% in relation to a baseline for Sample C1 shown as a line on the graph in FIG. 2D.

GO-containing membranes produced from freshly prepared samples of Samples C3, C4 and C5 (all containing EGPE and water) had an initial air permeance (FIG. 2C) much higher than the target performance threshold. FIG. 2C shows that EGPE-based formulations are unable to form coatings that meet the air tightness requirements.

FIG. 2D illustrates that EGPE-containing liquid coating compositions result in GO-containing membranes having reduced water vapor permeances compared to Sample C2 containing a ratio of EtOH:water of 80:20. Comparing FIG. 2D with FIG. 2B, the water vapor permeances of GO-containing membranes produced from EGPE-containing liquid coating compositions are much less than the water vapor permeances of GO-containing membranes produced from PGME-containing liquid coating compositions.

### Example 4—Rheology Comparisons

The viscosity of the liquid coating composition plays an important role in the usefulness of the liquid coating composition in coating processes, for example, for or in doctor blading and roll-to-roll printing processes. The viscosity needs to be sufficiently high for successful coating with these processes. Too low of a viscosity can result in the liquid coating composition running on the substrate while a coated web of the substrate travels to a drying oven, resulting in coating defects.

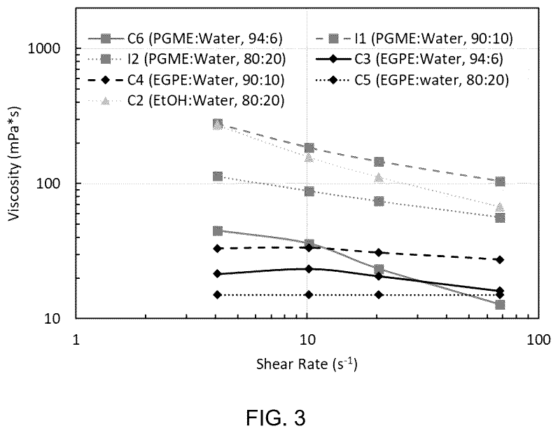

The viscosities of Samples C2, C3, C4, C5, C6, I1 and I2 were examined. FIG. 3 depicts a graph of viscosity (mPa*s) vs. shear rate (s⁻¹) for the Samples. FIG. 3 demonstrates that Samples C3, C4, C5 and C6 have low viscosities upon formulation of the compositions. Samples C3, C4 and C5 all contain EGPE as a co-solvent with water, demonstrating that the use of EGPE, which is closely related to PGME, is not as favorable as the use of PGME in coating applications requiring higher composition viscosities.

In addition, the EGPE-containing liquid coating compositions resulted in coatings that pooled after application and initial drying on a coating bed. Dripping/running of the EGPE-containing liquid coating compositions occurred during transfer of the coated membrane from the coating bed to the oven. The same was not observed for liquid coating composition containing PGME, including Sample C6 which contains PGME.

### Example 5—Total Solids Content Comparisons

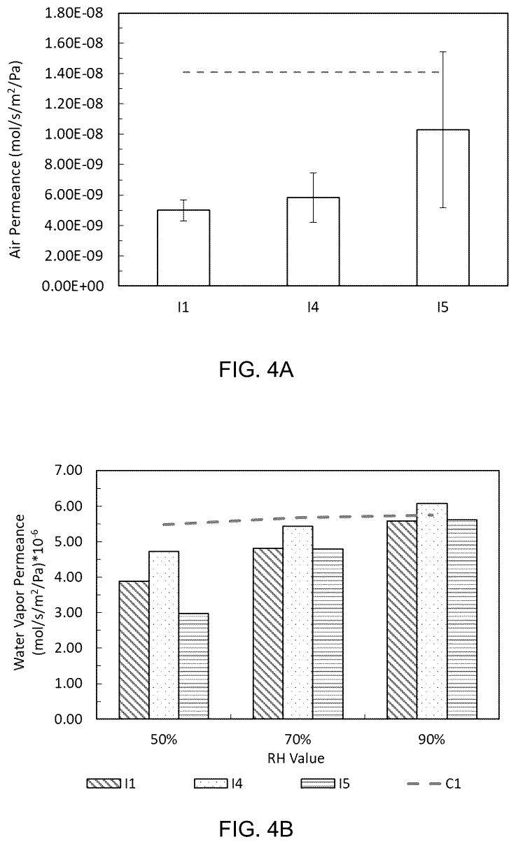

Air permeance and water vapor permeance for GO-containing membranes produced from freshly prepared samples of Samples I1, I4 and I5 were also examined to understand the effect of total solids content in PGME-containing GO liquid coating compositions. FIG. 4A depicts a graph of air permeance (mol/s/m²/Pa) of GO-containing membranes produced from the samples in relation to the target value of 1.41E-8 mol/s/m²/Pa, shown as a horizontal line in FIG. 4A. FIG. 4B depicts a graph of water vapor permeance (mol/m²*s*Pa)*10⁻⁶ of the GO-containing membranes produced from the samples at relative humidities (RH) of 50%, 70% and 90% in relation to a baseline for Sample C1 shown as a line on the graph in FIG. 4B.

FIG. 4A illustrates that a lower total solids content in the GO liquid coating composition results in a lower air permeance for the GO-containing membranes produced from the PGME-containing GO liquid coating composition. FIG. 4B illustrates that higher total solids content results in poorer water vapor permeance, especially at lower relative humidity. At higher relative humidity, the water vapor permeances of the GO-containing membranes produced from the PGME-containing GO liquid coating compositions (Samples I1, I4, I5) are as good or better than the water vapor permeance of the GO-containing membrane produced from Sample C1 (an EtOH-containing liquid coating composition).

The novel features will become apparent to those of skill in the art upon examination of the description. It should be understood, however, that the scope of the claims should not be limited by the embodiments but should be given the broadest interpretation consistent with the wording of the claims and the specification as a whole.

1. A graphene oxide liquid coating composition comprising graphene oxide (GO) suspended in a liquid medium, the liquid medium comprising at least 80% by volume of a mixture of water and propylene glycol monomethyl ether (PGME), the mixture having a volume ratio of PGME:water in a range of 80:20 to 95:5.

2. The composition of claim 1, wherein the volume ratio of PGME:water is in a range of 88:12 to 92:8.

3. The composition of claim 1, wherein the volume ratio of PGME:water is 90:10.

4. The composition of claim 1, wherein the liquid medium comprises at least 90% by volume of the mixture of water and PGME.

5. The composition of claim 1, wherein the liquid medium comprises at least 95% by volume of the mixture of water and PGME.

6. The composition of claim 1, wherein the liquid medium comprises 100% by volume of the mixture of water and PGME.

7. The composition of claim 1, wherein the GO is present in the composition at a concentration in a range of 1-50 mg/mL.

8. The composition of claim 1, wherein the GO is present in the composition at a concentration in a range of 10-25 mg/mL.

9. The composition of claim 1, wherein the GO is present in the composition at a concentration in a range of 15-20 mg/mL.

10. The composition of claim 1, further comprising a cellulose nanomaterial suspended in the liquid medium.

11. The composition of claim 10, wherein the cellulose nanomaterial comprises an aldehyde-modified cellulose nanomaterial.

12. The composition of claim 10, wherein the cellulose nanomaterial comprises cellulose nanofibers.

13. The composition of claim 10, wherein the cellulose nanomaterial is present in the composition at a concentration in a range of 0.1-10 mg/mL.

14. The composition of claim 1, wherein the composition has a shelf-life of 15 days or more.

15. The composition of claim 1, wherein the composition has a shelf-life of 28 days or more.

16. A method of producing a graphene oxide-containing membrane, the method comprising: coating a substrate with the graphene oxide liquid coating composition defined in claim 1; and, removing the liquid medium from the coated substrate.
